(19) United States
(12) Patent Application Publication
(10) Pub. No.: US 2003/0103567 A1
(43) Pub. Date: Jun. 5, 2003

(54) Motion compensation and/or estimation

(76) Inventors: Abraham Karel Riemens, Eindhoven (NL); Robert Jan Schutten, Campbell, CA (US); Selliah Rathnam, San Jose, CA (US); Andrea Maccato, Sunnyvale, CA (US); Kornelis Antonius Vissers, Sunnyvale, CA (US)

Correspondence Address: PHILIPS ELECTRONICS NORTH AMERICAN CORP, 580 WHITE PLAINS RD, TARRYTOWN, NY, 10591, US

(21) Appl. No.: 10/011,896

(22) Filed: Dec. 3, 2001

(51) Int. Cl. H04N 7/12

(52) U.S. Cl. 375/240.16

(57) ABSTRACT

For compensation and/or estimation of motion in a digital video image a search area or window (S) is defined for an actual image segment (BD-B) such that all data that can be accessed via motion vectors from all pixels in the actual image segment (BD-B) is contained in the search area (S).

The actual segment (BD-B) includes a number of pixel blocks positioned in a single horizontal row in the image and the search area (S) has a width in the horizontal direction including a higher number of pixel blocks. When progressing over the image the search are (S) is shifted from one segment to the next with a vertical scanning direction (SC).

An update area (UP-B) may be attached to the search area (S) to prepare for processing of the next image segment concurrently with processing of the actual segment.

The present invention relates to a method for motion compensation and/or estimation in a video image, by which data belonging to individual image segments are retrieved by shifting a predetermined search area over the image with a prescribed scanning direction, said search area defining a window comprising a group of one or more adjacent image segments and being contained in a search area memory.

In a sequence of images such as video images moving objects will generally appear in different zones of consecutive images.

In encoding of digital video signals it is well known to apply compression schemes such as MPEG-2 encoding to obtain significant reduction of the amount of data to be incorporated in the signal by arranging for complete encoding of only a part of the total number of consecutive images by use of various forms of motion estimation techniques to allow other images to be generated by prediction on the basis of encoded images, correlation between the parts of consecutive images, in which a moving object will appear, being ensured by incorporation in the encoded video signal of so-called motion vectors representing the spatial offset between a departure segment of an encoded image and an arrival segment of a succeeding predicted image.

A general disclosure of the application of motion estimation or compensation to digital video signal encoding in accordance with the MPEG standards is given e.g. in Herve Benoit: “Digital Television MPEG-1, MPEG-2 and principles of the DVB system”, London, 1997.

Another application of motion estimation or compensation is video scan rate conversion, where the output image rate of a video signal processing system differs from the input image rate. Also this type of application benefits from the use of motion vectors as described by Gerard de Haan et al in “True Motion Estimation with 3-D Recursive Block Matching”, IEEE Transactions on circuits and Systems for Video Technology, Vol. 3, No. 5, October 1993, and by Gerard de Haan in “IC for Motion-compensated De-interlacing, Noise Reduction and Picture-rate conversion”, IEEE Transactions on Consumer Electronics, Vol. 45, No. 3, August 1999.

For such encoding or scan rate conversion methods as well as other practical applications of motion estimation or compensation the determination of motion vectors is based on a technique known as block matching, by which for a selected image segment, which may be a generally square block of pixels, typically containing 8×8 pixels, a search area is defined that surrounds the corresponding pixel block in the succeeding image with this pixel block positioned in its centre and typically contains e.g. 88×40 pixels is defined. By block matching searching is effected through the search area for a pixel block containing pixel data matching that of the selected pixel block.

In present systems the image data of this search area or window is generally stored in a local buffer or on-chip memory having a size equal to the image width, which requires a relatively large buffer memory.

When a motion vector is to be assigned to a new segment such as a pixel block of an image the content of the search area must be updated by transfer of pixel blocks surrounding the new pixel block from the image stored in a background memory. This updating of the search area is made by a pipelining technique simultaneously with the image processing to optimise the total data throughput of the system.

It is an object of the present invention to provide a significantly improved way of updating the search area, whereby the image memory access can be optimized for improved efficiency. To this end, the invention provides a method and a device for motion estimation and/or compensation, and an apparatus as defined in the independent claims.

Advantageous embodiments are defined in the dependent claims.

A first embodiment of the invention is characterized by defining said image segment to include a first number of consecutive pixel blocks positioned in a single horizontal row in the image, defining the search area to have a horizontal extension and including a second number of consecutive pixel blocks equal to or higher than said first number, using a buffer memory capable of storing the actual search area and shifting the position of the search area over the image from one segment group to another with a vertical scanning direction.

By the particular formatting of image segments and the search area according to this method and the vertical scanning of the search window over the image being processed, which is thereby scanned in successive vertical columns, accessing requirements to the background memory can be reduced to simple consecutive horizontal memory access, whereby hardware restraints are reduced and processing time is shortened. Although the selected and corresponding image segments are relatively big, bandwidth requirements to the on-chip memory for storing the search area are still fully acceptable.

Preferably, the search area and the buffer memory have a width smaller than the image width.

In preferred embodiments, the defining of the search area is independent of the image width, and the buffer memory has a size independent on the image width. The image width is determined externally, e.g. 720 pixels but other values are also possible. The buffer memory width is determined by architecture considerations. A practical buffer memory width is a multiple of 8 pixels, e.g. 256 pixels. By making the search area and the buffer memory size independent of the image width, several image widths can be processed by the same architecture.

According to a particular advantageous implementation of the method, processing time may be further reduced by defining the search area to include a number of horizontal rows of pixel blocks, an update area being attached to the search area for pixel blocks in the next horizontal row in the scanning direction outside the search area.

For carrying out the method as defined the invention also relates to a device for motion compensation and/or estimation of a video image, comprising an image memory for at least temporary storing of images to be processed, means for selection of a group of one or more adjacent image segments from said image memory to form a search area for retrieval of data from image segments in said group and search area memory means for temporary storage of said group of segments.

According to the invention this device is characterized in that said selection means is controlled to include in said group only segments of an image stored in said image memory including a first number of consecutive pixel blocks positioned in a single horizontal row of said image, said search area memory means comprising a buffer memory of a size independent of the image width, but capable of storing a search area having a horizontal extension including a second number of consecutive pixel blocks equal to or higher than said first number, and said selection means being further controlled for successive supply of segment groups to be processed to said buffer memory with an order of succession, by which the position of the search area is shifted over the image with a vertical scanning direction.

According to a particularly advantageous embodiment of the motion estimation device, the storage capacity of said buffer memory is adapted to define the search area to include a number of horizontal rows of pixel blocks of said image, an update area being attached to the search area for pixel blocks in the next horizontal row in the scanning direction outside the current search area.

In connection with this embodiment the selection means is controlled for transfer of pixel blocks from a background image memory during the search of the search area.

The motion compensation and/or estimation method and device of the invention may be applied to all digital video signal processing functions involving the use of motion estimation or compensation such as motion compensated prediction in encoding of digital video signal, e.g. by the MPEG standard, motion compensated filtration in noise reduction, motion compensated interpolation in video format conversion, motion compensated de-interlacing of interlaced video signals etc.

In the following the invention will be explained in further detail with reference to the accompanying drawings, wherein

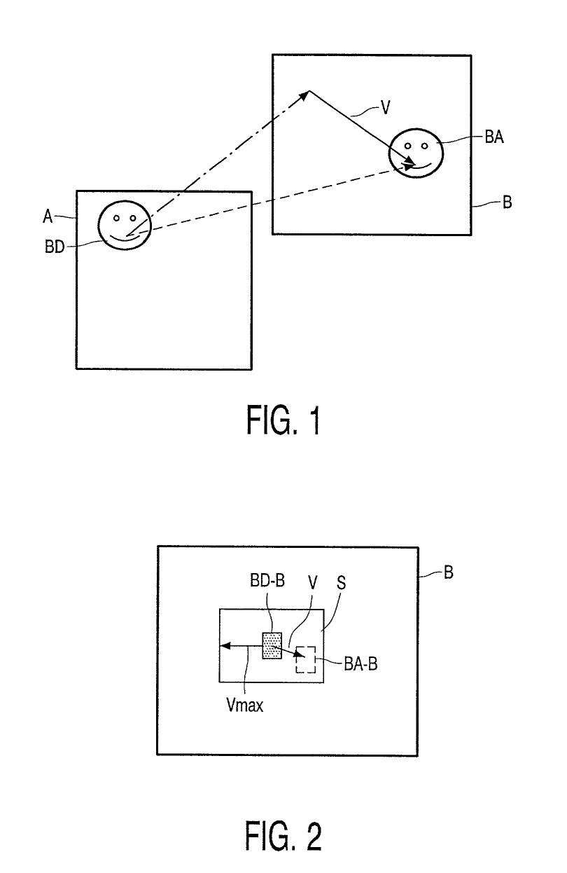

FIG. 1 is a simplified illustrative example of image prediction by use of motion estimation,

FIG. 2 illustrates determination of a motion vector by a prior art block-matching technique,

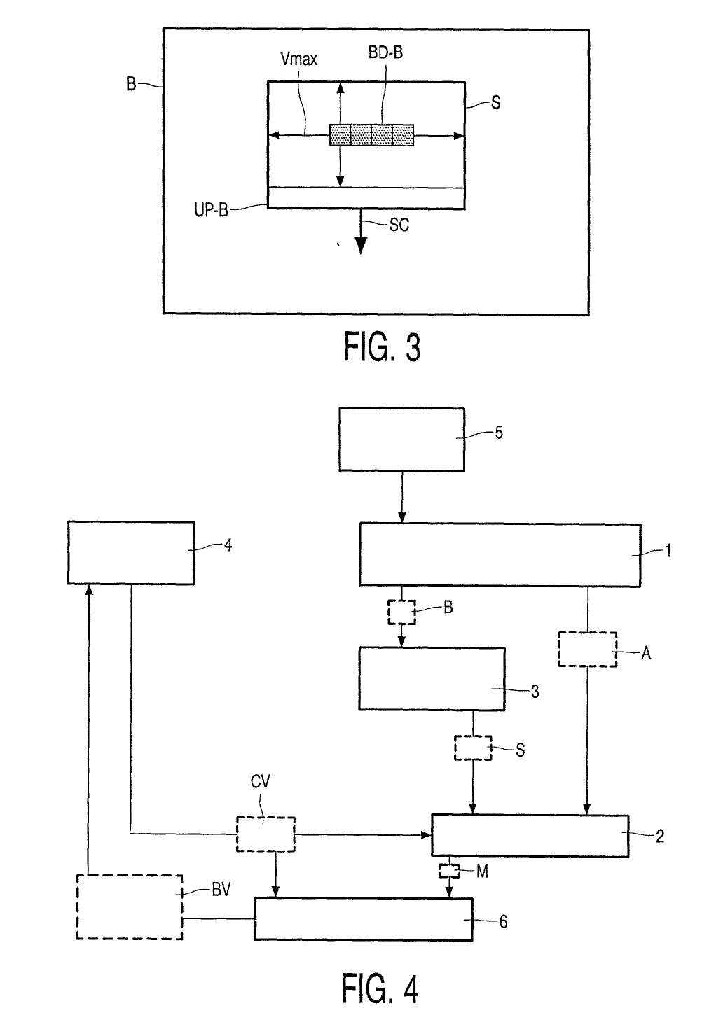

FIG. 3 illustrates motion vector determination with vertical search area scanning in accordance with the invention, and

FIG. 4 is a simplified block diagram of an estimation device according to the invention.

In FIG. 1 an example is given of the application of motion estimation to interpolation of an image in a sequence of consecutive images on the basis of a preceding image of the sequence. Such interpolation is typically used in video scan rate conversion, e.g. from 50 Hz into 100 Hz image format.

Each motion vector V describes the difference between the location of a departure segment BD in a first image A and an arrival zone BA in a second image B. Thus, the motion vector represents the movement of an individual object from the departure zone in the first image to the arrival zone in the second image.

FIG. 2 illustrates the determination of a motion vector V and its assignment to an image segment in the form of a block B of 8×8 pixels of an input video signal. The motion vector estimation is based on a so-called block matching technique as known in the art, by which selection is made of a pixel block BD-B in the image B, to which a motion vector V is to be assigned and a search area or window S to surround the actual pixel block BD-B in the image B. Typically, the search area S may comprise a number of pixel blocks surrounding the pixel block BD-B in the horizontal and vertical directions and for a block of 8×8 pixels the size of the search area S may be e.g. 88×40 pixels.

In popular terms, the motion vector V to be assigned to the actual pixel block BD-B is determined by searching the search area or window S for a pixel block BA-B matching the pixel block BD-A in the first image A.

By use of the block matching technique this searching process can be conducted with a varying level of complexity depending to some extent on the actual application of motion compensation or estimation, but involves typical selection of a best vector from a set of so-called candidate vectors stored in a prediction memory. Details of the searching process is not explained here, but comprehensive analysis of various options is given in Gerard de Haan et al: “True-motion Estimation with 3-D Recursive Search Block Matching”, IEEE transactions on Circuits and Systems for Video Technology, Vol.3, No. 5, October 1993 and Gerard de Haan: “IC for Motion-compensated De-interlacing, Noise Reduction and Picture-rate conversion”, IEEE Transactions on Consumer Electronics, Vol. 45, No. 3, August 1999, as mentioned hereinbefore.

In this way motion vectors may be determined for all pixel blocks of an image.

In the prior art method illustrated in FIG. 2 the content of the search area S must be updated for each assignment of a motion vector to a new image segment such as a pixel block and, since the search area must include a number of pixel blocks surrounding the selected pixel block both in vertical and horizontal directions. Such update for a pixel block causes heavy bandwidth demands to transfer image data to the search area buffer. For this reason, prior art systems typically use a local buffer containing the full width of the image. This does resolve the bandwidth issue, but has the clear disadvantage that the implementation poses a limitation on image size and furthermore the buffer must be relatively large.

As illustrated in FIG. 3, a selected image segment of an image is defined, according to the method of the invention, to include a number of consecutive pixel blocks positioned in a single horizontal row of the image. Moreover the search area S to surround the image segment BD-B is defined to have an extension in the horizontal direction including a second number of pixel blocks, which is higher than the number of blocks in the single row in the actual image segment BDP, which by itself may be positioned in the centre part of the search area S.

Combined with the essential feature that block matching and motion vector assignment to segments distributed vertically in the image are conducted by shifting the position of the search area S over the image from segment to another with a vertical scanning direction SC, the updating of the search area is significantly facilitated, since accessing requirements to the image memory can be reduced to simple horizontal memory access. Thereby, hardware restraints can be reduced and processing time is shortened.

Although the present invention requires more bandwidth to the local search than state of the art systems, it has turned out to be possible within fully acceptable bandwidth requirements, to equip the search area to process, as an example, 16 standard pixel blocks of 8×8 pixels each in the single horizontal row, i.e. of a horizontal length of 128 bytes, with a horizontal extension of 64 bytes on both sides to allow data access via motion vectors resulting in a width of 256 bytes corresponding to 32 standard pixel blocks. Updating of such a search area requires memory accesses of 256 consecutive memory addresses, which can be implemented very efficiently using state of the art memory systems. In this particular example, there is a bandwidth overhead of a factor of 2, since 256 bytes need to be loaded into the buffer to process 128 bytes of pixel data. In many systems, such bandwidth penalty is fully acceptable, but other trade-offs between the size of the buffer and the bandwidth are possible. In this particular example, the buffer has a width of only 256 bytes, which is a significant reduction compared to the full image width of 720 bytes as used in state of the art systems for processing standard video signals.

As illustrated in FIG. 3 the search area S may include a number of horizontal rows of pixel blocks, i.e. 5 rows corresponding to a vertical height of 40 bytes. In this connection, a further advantageous reduction of processing time can be obtained, if an update area UP-B is attached to the search area. When the shifting of the search area S over the image in the vertical scanning direction SC is effected with shifting of the actual segment from one row to the next, the availability of the update area UPD will allow transfer of pixel blocks for this next row to the update area, while block matching and motion vector determination for the current segment is in progress.

In the simplified block diagram in FIG. 4 of a possible motion estimator architecture for use e.g. in video scan rate conversion the motion estimation is performed on a pair of images A and B, stored in an image memory 1, from which image A comprising groups of image segments for which motion vectors are to be determined, is transferred to a block matcher 2. In the block matcher 2 a search for image segment groups or blocks in the image B matching predetermined image blocks in image A is conducted by application of a search window S transferred to the block-matcher 2 from a local buffer or search area memory 3 and by use of a set of candidate motion vectors CV transferred to the block matcher 2 from a vector memory 4.

The search area S temporarily stored in the buffer memory 3 contains a subset of the data of image B according to the present invention.

The vector memory 4 stores all motion vectors determined for segment groups or blocks of the preceding image and, for an image block to be searched in image A the set of candidate vectors may typically comprise motion vectors determined for an image block with same location in the preceding image or an adjacent image block in the current image.

The search area or window S is made up by transfer of the number of pixel blocks defined to surround the actual pixel block BD-B from the image memory 1 to the local buffer memory 3, in which the search area is kept stored for the duration of the searching and block matching process. Since, according to the invention the actual image segment is composed of pixel blocks positioned in the same horizontal row in the image, the transfer of pixel blocks for the search area S can be effected by simple horizontal line access to the memory 1 by selection means 5.

The block matching process conducted in block matcher 2 is known in the art and involves comparison or matching of blocks localized by application of the candidate vectors CV. Through this process a match M is found for each candidate vector. The best match is selected in a vector selector 6 and the corresponding best vector BV is stored in the vector memory 4 for use in the determination of future motion vectors.

Concurrently with the progress of block matching for an actual image segment, preparation is made for processing of the next segment by transfer of the corresponding pixel blocks from the image memory 1 to the search area memory 3 for inclusion in the update area UP-B.

For a person skilled in the art, it will be clear that a complete motion estimation device further comprises means to load image data into the image memory 1 and means to read vectors from vector memory 4 to be used in further processing.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, for compensation and/or estimation of motion in a digital video image a search area or window (S) is defined for an actual image segment (BD-B) such that all data that can be accessed via motion vectors from all pixels in the actual image segment (BD-B) is contained in the search area (S).

The actual segment (BD-B) includes a number of pixel blocks positioned in a single horizontal row in the image and the search area (S) has a width in the horizontal direction including a higher number of pixel blocks. When progressing over the image the search are (S) is shifted from one segment to the next with a vertical scanning direction (SC).

An update area (UP-B) may be attached to the search area (S) to prepare for processing of the next image segment concurrently with processing of the actual segment.

1. A method for motion compensation and/or estimation in a video image, by which data belonging to individual image segments (BD-B) are retrieved by shifting a predetermined search area (S) over the image with a prescribed scanning direction, said search area (S) defining a window comprising a group of one or more adjacent image segments and being contained in a search area memory (3), characterized by the steps of:
defining said image segment (BD-B) to include a first number of consecutive pixel blocks positioned in a single horizontal row in the image,
defining the search area (S) to have a horizontal extension and
including a second number of consecutive pixel blocks equal to or higher than said first number,
using a buffer memory (3) capable of storing the actual search area (S) and
shifting the position of the search area (S) over the image (B) from one segment group to another with a vertical scanning direction (SC).

2. A method as claimed in claim 1, wherein the defining of the search area is performed independent of the image size, and wherein the buffer memory has a size independent of the image width.

3. A method as claimed in claim 1, wherein the search area (S) is defined to include a number of horizontal rows of pixel blocks, an update area (UP-B) being attached to the search area for pixel blocks in the next horizontal row in the scanning direction outside the current search area.

4. A method as claimed in claim 1, wherein the entire image (B) is scanned column by column in the vertical direction.

5. A method as claimed in claim 1, characterized in that said first number is 16 pixel blocks of 8×8 pixels each and said second number is 32 pixel blocks.

6. A method as claimed in claim 1, characterized by its use for encoding of a digital video signal, whereby motion vector information is incorporated as prediction information in an encoded video signal for subsequent image prediction of by decoding of said video signal.

7. A method as claimed in claim 1, characterized by its use for motion compensated filtering in noise reduction in a digital video signal.

8. A method as claimed in claim 1, characterized by its use for motion compensated interpolation for video format conversion.

9. A method as claimed in claim 1, characterized by its use for motion compensated de-interlacing of an interlaced video signal.

10. A device for motion compensation and/or estimation of a video image, comprising an image memory (1) for at least temporary storing of images to be processed, means (5) for selection of a group of one or more adjacent image segments (BD-B) from said image memory (1) to form a search area (S) for retrieval of data from image segments in said group and search area memory means (3) for temporary storage of said group of segments, characterized in that said selection means (5) is controlled to include in said group only segments of an image stored in said image memory (1) including a first number of consecutive pixel blocks positioned in a single horizontal row of said image, said search area memory means comprising a buffer memory (3) capable of storing a search area (S) having a horizontal extension including a second number of consecutive pixel blocks equal to or higher than said first number, and said selection means (5) being further controlled for successive supply of segment groups to be processed to said buffer memory (3) with an order of succession, by which the position of the search area (S) is shifted over the image (B) with a vertical scanning direction (SC).

11. A device as claimed in claim 10, characterized in that the storage capacity of said buffer memory (3) is adapted to define the search area (S) to include a number of horizontal rows of pixel blocks of said image, an update area (UP-B) being attached to the search area (S) for pixel blocks in the next horizontal row in the scanning direction (SC) outside the current search area (S).

12. A device as claimed in claim 10, characterized in that said selection means (5) is controlled to transfer pixel blocks in said image to said update area (UP-B) from said image memory (1) during the search of the current search area (S).

13. A device as claimed in claim 10, characterized by its use in a system for encoding of a digital video signal, said device comprising means for incorporation of motion vector information as prediction information in an encoded video signal for subsequent image prediction by decoding of said video signal.

14. A device as claimed in claim 10, characterized by its use for motion compensated filtering in a system for noise reduction in a digital video signal.

15. A device as claimed in claim 10, characterized by its use for motion compensated interpolation in a system for video format conversion.

16. A device as claimed in claim 10, characterized by its use in a system for motion compensated de-interlacing of an interlaced video signal.

17. An apparatus for coding or reproducing video, the apparatus comprising:
an input unit for obtaining a video image, and
a device according to claim 10 for motion estimation and/or compensation of the video image.
